(19) United States
(12) Patent Application Publication
(10) Pub. No.: US 2023/0356385 A1
(43) Pub. Date: Nov. 9, 2023

(54) HEIGHT-ADJUSTABLE WORKING TABLE

(71) Applicant: PETec GmbH, Meschede (DE)

(72) Inventors: Christian PLETT, Schmallenberg (DE); Florian EICKELMANN, Eslohe (DE)

(73) Assignee: PETec GmbH, Meschede (DE)

(21) Appl. No.: 18/038,118

(22) PCT Filed: Nov. 26, 2021
(86) PCT No.: PCT/EP2021/083213

§ 371 Date: May 22, 2023

(30) Foreign Application Priority Data
Nov. 26, 2020 (LU) 102250

(51) Int. Cl. B25H 1/16

(52) U.S. Cl. CPC B25H 1/16

(57) ABSTRACT

A lifting column for a height-adjustable work table comprises a first hollow profile element and a second hollow profile element. The first hollow profile element encloses the second hollow profile element at least in sections. The second hollow profile element is telescopically displaceable in a displacement axis parallel to a vertical axis of the first hollow profile element. A guide device is arranged on the first hollow profile element and comprises a guide element that can be releasably connected to the guide device. A guide element surface of the at least one guide element abuts an outer surface of the second hollow profile element. A height-adjustable work table comprises at least two such lifting columns. A worktop is fixed to one end of the first hollow profile elements. The transmission units are connected to each other via a drive connection element and can be driven by the drive unit.

### CROSS-REFERENCE TO RELATED APPLICATION

This application is a national stage application, filed under 35 U.S.C. § 371, of International Patent Application PCT/EP2021/083213, filed on Nov. 26, 2021, which claims the benefit of Luxembourg Patent Application LU 102250, filed on Nov. 26, 2020.

### BACKGROUND

Work tables, such as heavy-duty tables or workbenches, are well-known from the workshop and industrial sectors. Such work tables are characterized by a particularly stable and robust design in order to be able to carry and accommodate particularly large loads of several hundred kilograms up to several tons. In addition, work tables are made of a resistant material in order to be resistant to the high stresses from the workshop area during everyday workshop work. For this purpose, the frame components, feet and worktop of the work tables are usually very large, solid and resistant. As a rule, a steel alloy is used as the material and steel components, such as steel profiles or beam girders, are used as the structural elements. This results in a load-bearing but particularly heavy and massive work table. The connection of the steel components can be made, for example, by a welded connection or by a bolted connection. Particularly when large steel components are joined to form a frame, the challenge is to keep the shape and position tolerances caused by production and assembly to a minimum. The heat input from a welding process when joining two steel components usually causes distortion of the steel component. In a bolted connection of two frame components, steel plates are first welded to the respective steel components. In a subsequent machining milling operation, the steel plates are machined to the desired geometry and threaded holes and bores are made in the steel plate. Only through the complex machining steps described above the position and shape tolerances required for precise adjustability of the heavy-duty tables are achieved.

Due to their solid construction, the work tables described above are mostly designed to be stationary. These work tables usually stand on rubber feet, which prevents the tables from slipping during everyday work and allows vibrations and shocks acting on the work table to be attenuated and damped. The work tables can only be moved by lifting them, for example with a lifting device such as a lift truck or an overhead crane. Although work tables are known that rest on lockable heavy-duty castors, the stability and damping properties of such work tables are significantly lower than those of work tables placed on rubber feet.

Height-adjustable work tables equipped with a lifting device for raising and lowering the worktop are also known from the prior art. A work table can be designed as a so-called scissor lift table. In a scissor lift table, the frame components are configured as scissors consisting of two legs of equal length. The legs move around a pivot joint at the center of the legs. On a fixed bearing side of the scissors, the scissors are connected to the base frame and the worktop. On a floating bearing side of the scissors, there are sliding rollers that slide on the base frame during a movement. A scissor lift table is usually driven by a hydraulic cylinder or a threaded shaft, which raises or lowers the work table by retracting or extending the lifting rod. An electric pump is used to build up the hydraulic pressure, or a manually operated foot pump is used. Although a foot pump can be used inexpensively, operation can be inconvenient due to poor accessibility of the foot pump, depending on the arrangement of the foot pump on the work table and the size of the worktop. In addition, depending on the size of the workload to be accommodated by the work table, operation of the foot pump may require a great deal of force. In addition, by using the foot pump, the worktop can only be raised in defined and relatively large steps. Thus, the achievable accuracy of the height adjustment of a scissor lift table is relatively low. In addition, due to the design of the scissor lift table, an area below the scissor lift table cannot be used because the scissors, the drive device and the hydraulic cylinder are located in this area. In addition, the exposed scissors, which are thus accessible from the outside, create a particularly high risk of crushing and injury to the operator. Enclosing the shears, for example by means of a collapsible box-shaped bellows enclosing the shears, would involve a great deal of effort.

Other embodiments of height-adjustable work tables comprise electrically adjustable lifting columns. In this case, the height adjustment of the lifting columns is implemented by means of electrically operated linear drives, wherein each linear drive comprises its own drive motor. In the case of a height-adjustable work table with several lifting columns, several linear drives and correspondingly several drive motors are thus required, making such height-adjustable work tables very cost-intensive. In addition, simultaneous adjustment of the lifting columns requires particularly complex synchronization of the linear drives, which leads to a complex and expensive configuration of the height-adjustable work table.

### SUMMARY

The disclosure relates to a lifting column for a height-adjustable work table, wherein the lifting column comprises at least a first hollow profile element and a second hollow profile element, wherein the hollow profile elements are arranged such that they can be telescoped relative to one another, wherein the first hollow profile element encloses the second hollow profile element at least in sections, wherein the second hollow profile element is displaceable in a displacement axis parallel to a vertical axis of the first hollow profile element.

It is considered to be an object of the present disclosure to provide a height-adjustable work table which has a high load-bearing capacity and can be manufactured at low cost.

This object is achieved in that the lifting column comprises a guide device arranged on the first hollow profile element and comprises at least one guide element which can be detachably connected to the guide device, wherein a guide element surface of the at least one guide element bears against an outer surface of the second hollow profile element. Thus, during a movement of the second hollow profile element relative to the first hollow profile element, the second hollow profile element slides along the guide element surface at the outer surface, whereby the second hollow profile element is guided within the first hollow profile element. In this case, the guide elements are configured to be interchangeable, so that guide elements with different thicknesses can be inserted into the guide device depending on the outer dimensions of the hollow profile elements used and to compensate for manufacturing tolerances. Furthermore, in an advantageous embodiment of the lifting column, it is provided that a plurality of guide elements are arranged along the circumference of the second hollow profile element and partially opposite one another. Thus, a particularly precise guidance of the second hollow profile element can be generated within the first hollow profile element.

The hollow profile elements described can be configured as structural steel tubes and take the form of rectangular tubes, square tubes or round tubes. Such structural steel tubes can be produced in different cross sections, in different lengths and with different wall thicknesses. Structural steel tubes are standard components which can be produced at low cost. The guide elements can be made from the same material as the hollow profile elements.

In an advantageous implementation, it is provided that the hollow profile elements are rectangular in shape. Due to the rectangular shape of the hollow profile elements, the guide elements can be flat and wide and the guide element surface of the one or more plate-shaped guide elements can be brought into contact with an outer surface of the second hollow profile element.

In an advantageous embodiment, it is provided that the guide element is plate-shaped and has a rectangular cross-section. Such plate-shaped guide elements can be manufactured or obtained from different materials at particularly low cost.

In order to produce a particularly large contact surface between the guide device and the guide element, an advantageous embodiment of the lifting column provides that the guide device is configured in such a way that the guide device completely covers the guide element on a side of the guide element opposite the guide element surface. This makes it possible for the guide element to be seated particularly securely within the guide device. In addition, the guide element can be mounted within the guide device in a contact-safe manner.

The relative movement of the hollow profile elements generates friction in a friction surface area between the outer surface of the second hollow profile element and the guide element surface, which leads to abrasive wear of the guide element surface or the second hollow profile element. Since the guide elements are configured to be replaceable, they can be replaced in the event of wear. In order that, in the event of relative movement between the second hollow profile element and the guide element, the predominant proportion of the wear occurring in the friction surface area occurs on the guide element, which can be produced inexpensively, it is provided in an advantageous embodiment that the guide element surface is produced, at least in sections, from a soft material whose hardness is lower than that of the second hollow profile element. Thus, wear occurs predominantly or exclusively at the guide element surface, whereby the guide element wears at the guide element surface during the operating time without the outer surface of the second hollow profile element being worn. Thus, the wear occurs exclusively on the low-cost component, which can be readily replaced in case of wear. This enables particularly cost-effective operation of the lever column.

In order to achieve a particularly long operating time of the lifting column, an advantageous embodiment of the lifting column provides that the guide element is made entirely of a soft material. As a result, the guide element subject to wear can be kept in use for a particularly long time. The guide element can be made of a soft material, such as copper or brass or an alloy containing copper or brass. Such plate-shaped guide elements made of a material containing copper or brass are also standard components that can be manufactured and obtained at low cost. This makes it possible to manufacture and operate the lifting column at particularly low cost.

In order to be able to maintain a constant and uniform contact pressure of the guide element on the outer surface of the second hollow profile element at all times during operation of the lifting column, in an advantageous embodiment it is provided that the guide device comprises a clamping device by means of which a clamping force can be applied, by which the at least one guide element can be displaced in the direction of the outer surface of the second hollow profile element. Such a clamping force could be generated, for example, by a preloaded compression spring which is arranged between the clamping device and the guide element and generates a clamping force that acts in the direction of the outer surface of the second hollow profile element.

In order to be able to apply a particularly high clamping force to the guide element, an advantageous embodiment provides that the clamping force of the clamping device can be preset by means of a screw connection. In addition, the clamping force generated by a screw connection can be adjusted particularly precisely and easily. A screw of the screw connection can also be used to secure the guide element within the clamping device against loss by screwing the screw used for applying the clamping force into a threaded hole of the guide element.

In an advantageous embodiment of the lifting column, it is provided that the lifting column comprises a transmission unit connecting the hollow profile elements, by means of which the first hollow profile element and the second hollow profile element can be displaced relative to one another, wherein the transmission unit is enclosed by the first and/or the second hollow profile element. By means of the transmission unit, a displacement between the two hollow profile elements can be effected particularly precisely. Since transmission units generally have movable gear components, it is particularly advantageous that the transmission unit in the lifting column is enclosed by the first and/or the second hollow profile element. This eliminates the risk of injury from reaching into the area of the moving gear components.

In an advantageous embodiment of the lifting column, it is provided that the transmission unit is configured as a ball screw, wherein the ball screw comprises a threaded shaft and a ball screw nut. A ball screw is a screw drive in which balls guided helically inside the ball screw nut and inside a closed and circumferential ball receiving channel transmit the force between the threaded shaft and the ball screw nut. When rotational movement occurs between the threaded shaft and the ball screw nut, the balls roll in the ball receiving channel and move toward the front end of the nut. Ball screws exhibit particularly low friction and low wear while maintaining uniform movement between the ball screw nut and the threaded shaft. Due to the usually slim design of the ball screw, it can be installed particularly easily in the hollow profile elements so that it is enclosed by the first hollow profile element and/or the second hollow profile element. Ball screws are widely used standard assemblies and can be manufactured particularly inexpensively or purchased inexpensively as pre-assembled assemblies or in individual parts.

In an advantageous implementation, it is provided that the transmission unit can be driven by means of a drive unit. A movement of the ball screw nut relative to the threaded shaft in a longitudinal direction of the threaded shaft can be effected either by a rotary movement of the ball screw nut or by a rotary movement of the threaded shaft. Depending on whether the threaded shaft or the ball screw nut is driven, a handwheel, an electric motor or a construction machine can be used as the drive unit.

In an advantageous embodiment of the lifting column, it is provided that the ball screw nut of the ball screw is fixed to one end of the second hollow profile element and the end region of the threaded shaft protrudes from the second hollow body element. The ball screw nut can be particularly easily fixed to the end face of the second hollow profile element via the standardized connecting flange of the ball screw nut. The fact that the threaded shaft protrudes from the second hollow body element means that a drive unit driving the threaded shaft can be attached particularly easily to the area of the threaded shaft that protrudes from the second hollow body element.

In order to create a coupling between the drive unit and the threaded shaft that is particularly easy to implement, an advantageous embodiment provides for a threaded shaft of the ball screw to be driven by means of the drive unit via a drive wheel fixed to an end region of the threaded shaft. The drive wheel can be fixed to the threaded shaft either positively, for example by means of a so-called key connection, or non-positively, for example by means of a press connection.

In order to be able to design the drive wheel particularly cost-effectively and to be able to fix it easily to the end region of the threaded shaft, in an advantageous embodiment of the lifting column it is provided that threads are removed from the end region of the threaded shaft by means of mechanical machining and the end region is separated from the threads by an abutment element. Mechanical removal of the threads, for example by turning the threaded shaft, produces a smooth end region of the threaded shaft. The drive wheel can be pushed onto this smooth end region particularly easily. By forming a longitudinal groove on an outer side of the threaded shaft in the end region of the threaded shaft, the drive wheel can be connected to the threaded shaft, for example, via a keyway connection. To prevent the drive wheel from resting directly against the ends of the threads of the threaded shaft, an abutment element is provided, against which the drive wheel is brought into abutment. In this way, a particularly precise position of the drive wheel on the threaded shaft can be achieved, so that simple and fast assembly and a long service life of the lifting column are ensured.

In order to be able to prevent a jerky stop of the threaded shaft or a component of the lifting column in an end position of the threaded shaft, in an advantageous embodiment it is provided that the threaded shaft comprises a stop element at least at one end region of the threaded shaft, which comes into contact with the ball screw nut and/or with a frame component when the threaded shaft approaches an end position. Advantageously, the stop element can be made of a material that is elastically deformable and has damping properties. This enables particularly safe operation of the lifting column.

In order to configure the stop element with particularly small external dimensions, an advantageous implementation is that the stop element surrounds the threaded shaft at least in sections along an outer circumferential surface of the threaded shaft. The stop element can be placed on threads of the threaded shaft. Thus, a screw movement of the stop element can change a position of the stop element on the threaded shaft, so that the end positions of the height adjustment can be adjusted particularly easily when the lifting column is mounted.

In order that an impact-like movement can be particularly well damped and cushioned when the end positions of the threaded shaft are approached on a component of the lifting column, an advantageous embodiment of the lifting column provides that the stop element consists of an elastically deformable material. The elastically deformable material can, for example, be a rubber-like material or an elastic plastic, which can also have damping properties.

In an advantageous implementation, the stop element is configured as a spring element. The spring element can be configured as a spiral compression spring and be fixed to the threaded shaft in an end region of the threaded shaft. In this way, a jerky movement can be reduced particularly well when the threaded shaft moves to an end position.

The object set out at the beginning is also achieved by a height-adjustable work table comprising at least two of the lifting columns described above. In this case, the height-adjustable work table comprises, at one end of the first hollow profile elements, a worktop which is fixed to the first hollow profile element. In an advantageous embodiment of the height-adjustable work table, it is provided that the transmission units are connected to one another via a drive connection element and can be driven by means of the drive unit. In this case, only one drive unit is used to operate both transmission units. This enables a particularly cost-effective configuration of the height-adjustable work table.

It is also possible and provided that the worktop is arranged at a lower end of the first hollow profile element. Thus, when the lifting column is not extended, the worktop is at a low height or at a short distance from the base of the height-adjustable work table. This makes it particularly easy to load the worktop or process a workpiece at a low working height.

It can also be advantageously provided that the lifting columns of the height-adjustable work table comprise a third hollow profile element which is slid over the first hollow profile element and encloses the first hollow profile element and the second hollow profile element. In this case, the third hollow profile element is fixed to the end of the second hollow profile element, so that when the second hollow profile element moves relative to the first hollow profile element, the third hollow profile element is displaced parallel to the latter. Thus, a particularly low overall height of the height-adjustable work table can be achieved.

In order to be able to guide the drive connecting element connecting the transmission units particularly safely between the transmission units or between the lifting columns, an advantageous embodiment provides that the drive connecting element can be guided within a connecting hollow profile element arranged between the lifting columns. The connecting hollow profile elements can also be made from standard components, such as rectangular hollow sections, analogously to the hollow profile elements of the lifting column. Thus, the use of standard components enables a particularly cost-effective configuration of the height-adjustable work table.

Further advantageous configurations of the lifting column are explained with reference to exemplary embodiments shown in the drawings.

### BRIEF DESCRIPTION OF THE DRAWINGS

FIG. 1 shows a schematic illustration of the lifting column in a sectional view,

FIG. 2 shows a schematic illustration of the guiding device and

FIG. 3 shows a schematic illustration of a height-adjustable work table.

### DETAILED DESCRIPTION

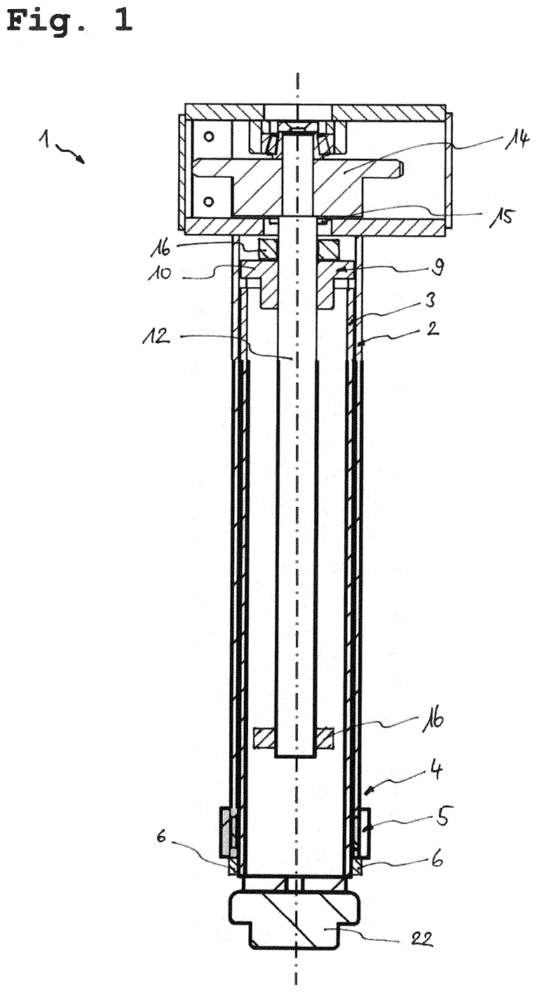

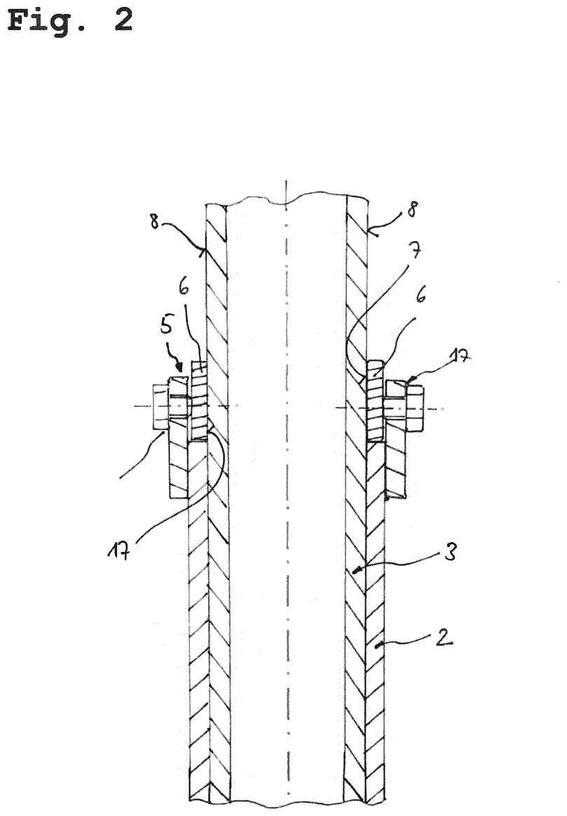

FIG. 1 shows a schematic illustration of a lifting column 1 in a sectional view. The lifting column 1 comprises a first hollow profile element 2 and a second hollow profile element 3, which are arranged so as to be telescopic relative to one another. The hollow profile elements 2,3 are each configures as hollow tubes with a square cross-section. The second hollow profile element 3 is arranged inside the first hollow profile element 2 and is partially enclosed by the latter. In an upper edge region 4 of the first hollow profile element 2, a guide device 5 with guide elements 6 is attached as shown in FIG. 2. The two hollow profile elements 2,3 are movably connected to each other via a transmission unit 9 enclosed by the first hollow profile element 2 and/or the second hollow profile element 3. The transmission unit 9 is configured as a ball screw 10, which comprises a ball screw nut 11 and a threaded shaft 12. The ball screw nut 11 is arranged and fixed at one end of the second hollow profile element 3. By mechanically machining the threaded shaft 12 in an end region 13 of the threaded shaft 12, a shaft shoulder having a keyway formed therein is formed. A drive wheel 14 is pushed onto this shaft shoulder and fixed to the threaded shaft 12 by means of a key connection. In the process, the drive wheel 14 is pushed onto the shaft shoulder until it rests against an abutment element 15. The abutment element 15 is formed by a spacer washer welded to the end of the shaft shoulder. The threaded shaft 12 comprises a stop element 16 made of a rubber-like material in each of the two end regions. By means of the stop elements 16, the two end positions of the traverse movement of the threaded shaft 12 are fixed. Thereby, in the end positions of the threaded shaft 12, the respective stop element 16 is brought into contact with the ball screw nut 11 or a frame component and the shock-like contact is thus damped. The lifting column 1 rests on a machine base 22 attached to the lower end of the second hollow profile element 3.

FIG. 2 shows a schematic illustration of the guide device 5. Here, the guide elements 6 are arranged around the circumference of the second hollow profile element 3 and are detachably connected to the guide device 5. The guide element surface 7 of the guide element 6 rests against an outer surface 8 of the second hollow profile element 3. The guide elements 6 are made entirely of a brass alloy, the hardness of which is lower than that of the second hollow profile element. The guiding device 5 comprises a clamping device 17, which is configured as a screw connection. By means of the screw connection, a clamping force can be applied with which the guide elements 6 are displaced in the direction of the outer surface 8 of the second hollow profile element 3. The level of the clamping force can be used to achieve play-free guidance of the second hollow profile element 3 within the first hollow profile element 2.

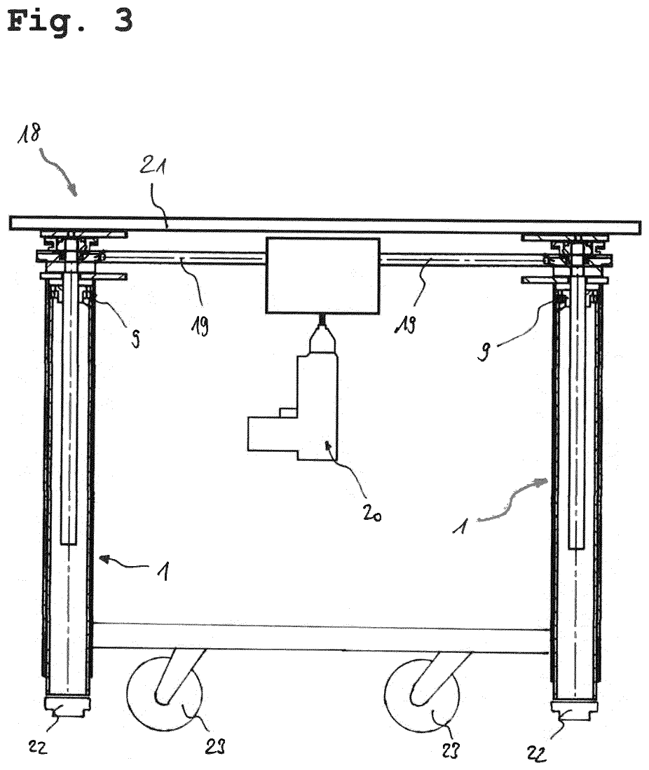

FIG. 3 shows a schematic illustration of a height-adjustable work table 18 with multiple lifting columns 1. The height-adjustable work table 18 comprises a worktop 21 that is fixed to the first hollow profile element 2. In this case, the transmission units 9 of the lifting columns 1 are connected to one another via a drive connecting element 19 configured as a drive chain. The drive chain can be driven via a common drive unit 20. In this exemplary embodiment, the drive unit 20 is configured as an electric drill, whereby the drive torque applied by the electric drill is transmitted to the transmission units 9 via a worm gear via the drive connection element 19. After the height-adjustable work table 18 has been adjusted, the electric drilling machine can be disconnected from the worm gear again. In a compressed state of the lifting column 1, the work table 19 rests on the ground via a plurality of heavy-duty rollers 23, with no contact between the machine feet 22 and the ground. Thus, the work table 18 can be moved manually.

1.-20. (canceled)

21. A lifting column (1) for a height-adjustable work table (18), comprising:
a first hollow profile element (2);
a second hollow profile element (3); and
a guide device (5) arranged on the first hollow profile element (2) and having a guide element (6) which can be releasably connected to the guide device (5),
wherein the first hollow profile element (2) and the second hollow profile element (3) are arranged such that they can be telescoped relative to one another,
wherein the first hollow profile element (2) encloses the second hollow profile element (3) at least in sections,
wherein the second hollow profile element (3) is displaceable in a displacement axis parallel to a vertical axis of the first hollow profile element (2), and
wherein a guide element surface (7) of the guide element (6) bears against an outer surface (8) of the second hollow profile element (3).

22. The lifting column (1) according to claim 21,
wherein the first hollow profile element (2) and the second hollow profile element (3) are rectangular.

23. The lifting column (1) according to claim 21,
wherein the guide element (6) is plate-shaped and has a rectangular cross-section.

24. The lifting column (1) according to claim 21,
wherein the guide device (5) is configured in such a way that the guide device (5) completely covers the guide element (6) on a side of the guide element (6) opposite the guide element surface (7).

25. The lifting column (1) according to claim 21,
wherein the guide element surface (7) is made, at least in sections, of a soft material whose hardness is lower than that of the second hollow profile element (3).

26. The lifting column (1) according to claim 21,
wherein the guide element (6) is made entirely of a soft material.

27. The lifting column (1) according to claim 21,
wherein the guide device (5) comprises a clamping device (17) by which a clamping force can be applied, by which the guide element (6) can be displaced in a direction of an outer surface of the second hollow profile element (3).

28. The lifting column (1) according to claim 27,
wherein the clamping force of the clamping device (17) can be preset by a screw connection.

29. The lifting column (1) according to claim 21,
wherein the lifting column (1) comprises a transmission unit (9) which connects the first hollow profile element (2) and the second hollow profile element (3) and by which the first hollow profile element (2) and the second hollow profile element (3) can be displaced relative to one another,
wherein the transmission unit (9) is enclosed by the first hollow profile element (2) and/or the second hollow profile element (3).

30. The lifting column (1) according to claim 29,
wherein the transmission unit (9) is configured as a ball screw (10), and
wherein the ball screw (10) comprises a threaded shaft (12) and a ball screw nut (11).

31. The lifting column (1) according to claim 30,
wherein the transmission unit (9) can be driven by means of a drive unit (20).

32. The lifting column (1) according to claim 30,
wherein the ball screw nut (11) of the ball screw (10) is fixed to one end of the second hollow profile element (3) and an end region (13) of the threaded shaft (12) protrudes from the second hollow profile element.

33. The lifting column (1) according to claim 31,
wherein the threaded shaft (12) of the ball screw (10) is driven by the drive unit (20) via a drive wheel (14) fixed to an end region (13) of the threaded shaft (12).

34. The lifting column (1) according to claim 32,
wherein threads are removed from the end region (13) of the threaded shaft (12) by mechanical machining and the end region (13) is separated from the threads by an abutment element (15).

35. The lifting column (1) according to claim 30,
wherein the threaded shaft (12) comprises, at least at one end region (13) of the threaded shaft (12), a stop element (16) which, in an end position of the threaded shaft (12), is in contact with the ball screw nut (11) and/or with a frame component.

36. The lifting column (1) according to claim 35,
wherein the stop element (16) surrounds the threaded shaft (12) at least in sections along an outer circumferential surface of the threaded shaft (12).

37. The lifting column (1) according to claim 35,
wherein the stop element (16) consists of an elastically deformable material.

38. The lifting column (1) according to one of claim 35,
wherein the stop element (16) is configured as a spring element.

39. A height-adjustable work table (18), comprising
at least two lifting columns (1) according to claim 29,
wherein a worktop (21) is fixed in an end region (13) of the first hollow profile elements (2), and
wherein the transmission units (9) are connected to one another via a drive connection element (19) and can be driven by means of the drive unit (20).

40. The height-adjustable work table (18) according to claim 39,
wherein the drive connecting element (19) is guidable within connecting hollow profile elements arranged between the lifting columns (1).
